(19) United States
(12) Patent Application Publication
(10) Pub. No.: US 2011/0225557 A1
(43) Pub. Date: Sep. 15, 2011

(54) HIGH-LEVEL SYNTHESIS APPARATUS, HIGH-LEVEL SYNTHESIS METHOD, AND COMPUTER READABLE MEDIUM

(75) Inventor: Toru FUJITA, Kawasaki-Shi (JP)

(73) Assignee: KABUSHIKI KAISHA TOSHIBA, Tokyo (JP)

(21) Appl. No.: 13/048,650

(22) Filed: Mar. 15, 2011

(30) Foreign Application Priority Data
Mar. 15, 2010 (JP) 2010-57326

(51) Int. Cl. G06F 9/45

(52) U.S. Cl. 716/103

(57) ABSTRACT

A high-level synthesis apparatus includes an internal representation generator, a scheduler, a frequency controller, an allocator, a register transfer level description generator, and an outputting module. The internal representation generator generates internal representation from behavioral description of a semiconductor integrated circuit. The scheduler schedules arithmetic operations in the internal representation. The frequency controller changes a clock frequency of the semiconductor integrated circuit based on a result of the scheduler. The allocator fixes a circuit configuration of the semiconductor integrated circuit behaving at the changed clock frequency. The register transfer level description generator generates register transfer level description from the internal representation based on a result of the allocator. The outputting module outputs the register transfer level description.

### CROSS REFERENCE TO RELATED APPLICATIONS

This application is based upon and claims the benefit of priority from the prior Japanese Patent Application No. 2010-57326, filed on Mar. 15, 2010, the entire contents of which are incorporated herein by reference.

### FIELD

The present invention relates to a high-level synthesis apparatus, a high-level synthesis method, and a computer readable medium.

### BACKGROUND

Conventionally, in a high-level synthesis used to design a semiconductor integrated circuit, internal representation such as a CDFG (Control Data Flow Graph) is generated from behavioral description, scheduling and allocation are done based on the internal representation, and an RTL (Register Transfer Level) description is generated based on the scheduling and allocation results.

In order to reduce power consumption of the semiconductor integrated circuit, it is necessary for a designer to reduce power consumption of cells that realizes the RTL description generated in the high-level synthesis (for example, to select a cell whose power consumption is low) or to adopt a clock gating technology.

However, the reduction of the power consumption of the semiconductor integrated circuit by selecting the module whose power consumption is low or adapting the clock gating technology is limited.

That is, it is difficult to further reduce the power consumption of the semiconductor integrated circuit from the conventional high-level synthesis result.

### BRIEF DESCRIPTION OF THE DRAWINGS

FIG. 1 is a block diagram illustrating a configuration of a system including a high-level synthesis apparatus 10 of the embodiment.

FIG. 2 is a block diagram illustrating a configuration of the high-level synthesis apparatus 10 of FIG. 1.

FIG. 3 is a block diagram illustrating a configuration of a frequency controller 14 of FIG. 2.

FIG. 4 is a flowchart illustrating a procedure of the high-level synthesis operation of the embodiment.

FIG. 5 is a schematic diagram illustrating an example of the scheduled CDFG generated in scheduling (S403) of FIG. 4.

FIG. 6 is a flowchart illustrating the procedure of controlling frequency (S404) of FIG. 4.

FIG. 7 is a schematic diagram illustrating an example of the CDFG corresponding to an operation result in changing clock frequency (S602) of FIG. 6.

FIG. 8 is a flowchart illustrating the procedure of chaining (S603) of FIG. 6.

FIG. 9 is a schematic diagram illustrating an example of a chaining table used in chaining (S603) of FIG. 6.

FIG. 10 is a schematic diagram illustrating an example of an operation result of chaining (S603) of FIG. 6.

### DETAILED DESCRIPTION

Embodiments will now be explained with reference to the accompanying drawings.

According to one embodiment, a high-level synthesis apparatus includes an internal representation generator, a scheduler, a frequency controller, an allocator, a register transfer level description generator, and an outputting module. The internal representation generator generates internal representation from behavioral description of a semiconductor integrated circuit. The scheduler schedules arithmetic operations in the internal representation. The frequency controller changes a clock frequency of the semiconductor integrated circuit based on a result of the scheduler. The allocator fixes a circuit configuration of the semiconductor integrated circuit behaving at the changed clock frequency. The register transfer level description generator generates register transfer level description from the internal representation based on a result of the allocator. The outputting module outputs the register transfer level description.

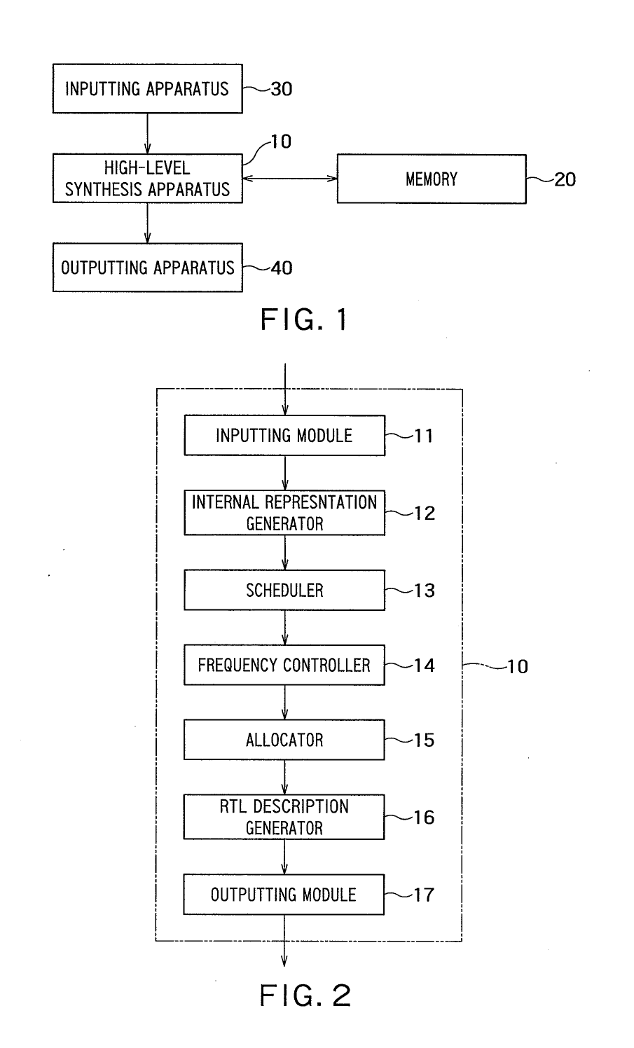

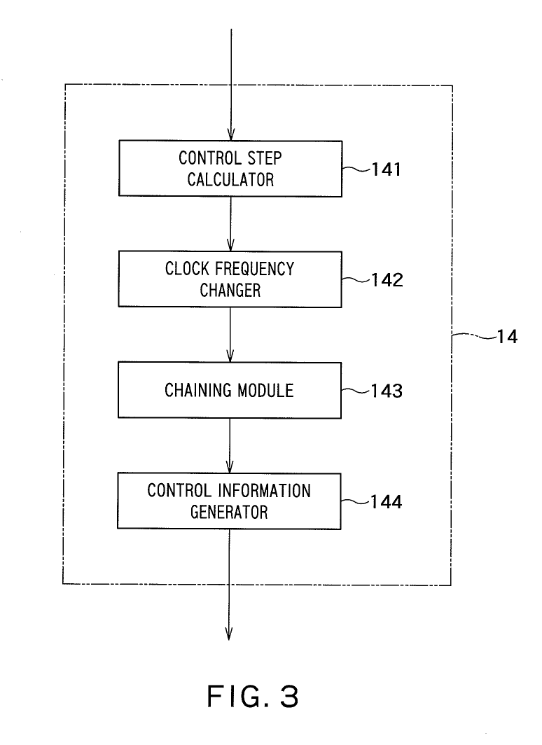

A configuration of the high-level synthesis apparatus according to an embodiment will be explained below. FIG. 1 is a block diagram illustrating a configuration of a system including a high-level synthesis apparatus 10 of the embodiment. FIG. 2 is a block diagram illustrating a configuration of the high-level synthesis apparatus 10 of FIG. 1. FIG. 3 is a block diagram illustrating a configuration of a frequency controller 14 of FIG. 2.

As illustrated in FIG. 1, the high-level synthesis apparatus 10 is connected to a memory 20, an inputting apparatus 30, and an outputting apparatus 40. A high-level synthesis program to realize a function of the high-level synthesis apparatus 10 is stored in the memory 20. The inputting apparatus 30 is used when a user inputs information necessary for an operation of the high-level synthesis apparatus 10. For example, the inputting apparatus 30 is a keyboard. The outputting apparatus 40 is used when the user views the operation result of the high-level synthesis apparatus 10. For example, the outputting apparatus 40 is a display.

As illustrated in FIG. 2, the high-level synthesis apparatus 10 includes an inputting module 11, an internal representation generator 12, a scheduler 13, the frequency controller 14, an allocator 15, an RTL description generator 16, and an outputting module 17.

The inputting module 11 of FIG. 2 is configured to receive the information that is inputted by the user using the inputting apparatus 30. More specifically, the inputting module 11 receives the behavioral description of the semiconductor integrated circuit, constraint information, such as a clock frequency, indicating a constraint of the semiconductor integrated circuit, and a library including a parameter of the semiconductor integrated circuit.

The internal representation generator 12 of FIG. 2 is configured to generate the internal representation from the behavioral description. More specifically, the internal representation generator 12 converts arithmetic operations of the behavioral description into nodes, and generates the CDFG by expressing a variable indicating a data flow between the arithmetic operations by arrows connecting the nodes.

The scheduler 13 of FIG. 2 is configured to schedule the arithmetic operations in the internal representation generated by the internal representation generator 12. More specifically, the scheduler 13 schedules each arithmetic operation of the CDFG to a control step so as to satisfy a data dependency and the constraint indicated by the constraint information. In other words, the scheduler 13 disposes each arithmetic operation of the CDFG in the proper control step based on the constraint information. One or more arithmetic operations that can be executed by one clock cycle are allocated to one control step.

The frequency controller 14 of FIG. 2 is configured to change the clock frequency of the module which executes the arithmetics based on the result of the scheduler 13. As illustrated in FIG. 3, the frequency controller 14 includes a control step calculator 141, a clock frequency changer 142, a chaining module 143, and a control information generator 144.

The control step calculator 141 of FIG. 3 is configured to calculate the number of control steps (hereinafter referred to as a “necessary control step”) necessary for the module to do all the arithmetics.

The clock frequency changer 142 of FIG. 3 is configured to reduce the clock frequency of the module based on the number of control steps calculated by the control step calculator 141.

The chaining module 143 of FIG. 3 is configured to change the control step of the arithmetic operation that is executed by the module by considering the reduced clock frequency.

The control information generator 144 of FIG. 3 is configured to generate control information. The control information includes a value of change of the clock frequency and identification of the modules which have the reduced clock frequency.

The allocator 15 of FIG. 2 is configured to fix a circuit configuration of the semiconductor integrated circuit such that the module behaves at the clock frequency changed by the frequency controller 14. In other words, the allocator 15 converts each arithmetic operation of the CDFG scheduled by the scheduler 13 into a proper circuit element such as an arithmetic unit.

The RTL description generator 16 of FIG. 2 is configured to generate the RTL description from the internal representation based on the result of the allocator 15.

The outputting module 17 of FIG. 2 is configured to output the RTL description generated by the RTL description generator 16 and the control information generated by the control information generator 144.

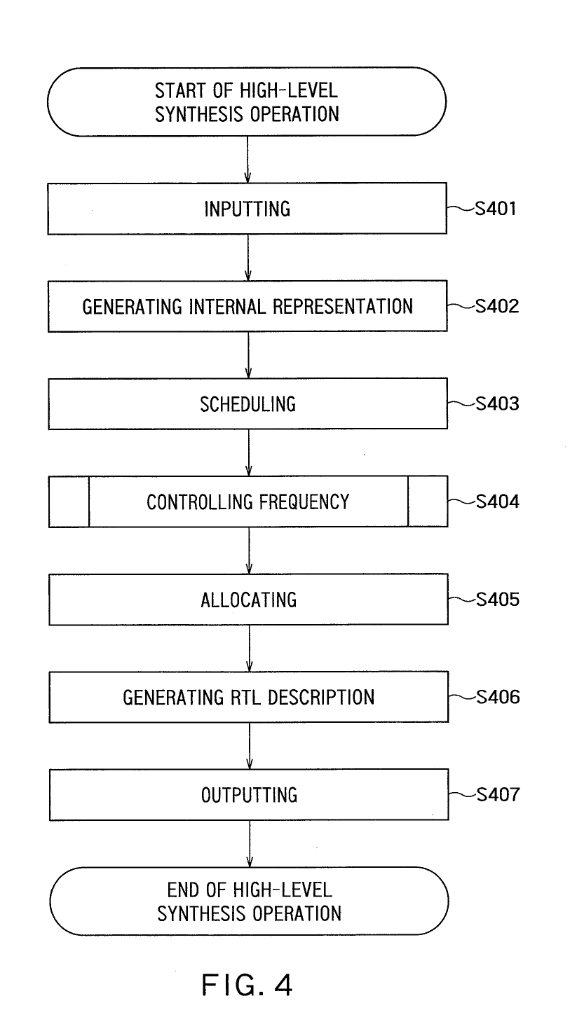

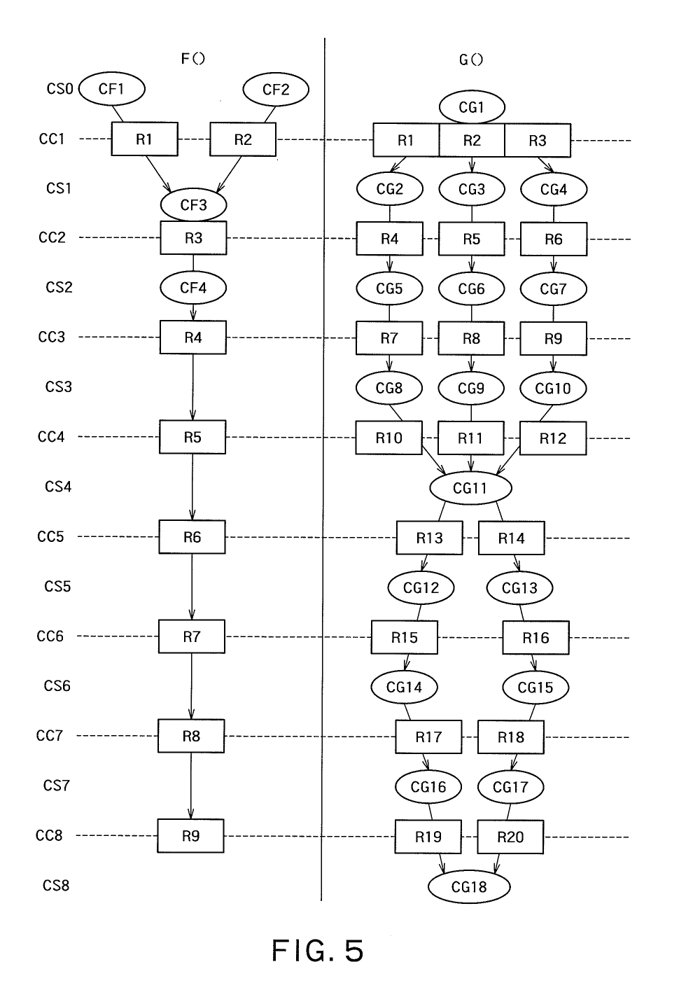

A high-level synthesis operation of the embodiment will be explained below. FIG. 4 is a flowchart illustrating a procedure of the high-level synthesis operation of the embodiment. FIG. 5 is a schematic diagram illustrating an example of the scheduled CDFG generated in scheduling (S403) of FIG. 4.

<FIG. 4: inputting (S401)> The inputting module 11 receives the behavioral description, the constraint information, and the library from the inputting apparatus 30. For example, the constraint information indicates that the clock frequency is 100 MHz and the constraint (hereinafter referred to as a “cycle constraint”) of the number of cycles in which the module operates is 8 cycles. Therefore, the information necessary for the high-level synthesis operation is supplied to the high-level synthesis apparatus 10.

<FIG. 4: generating internal representation (S402)> The internal representation generator 12 generates the internal representation from the behavioral description received in inputting (S401).

<FIG. 4: scheduling (S403)> The scheduler 13 schedules the arithmetic operations in the internal representation generated in generating internal representation (S402), thereby generating the scheduled internal representation. An execution step of the arithmetic operation in the behavioral description is fixed in the scheduled internal representation. More specifically, the scheduler 13 schedules the CDFG using an ASAP (As Soon As Possible) algorithm or an ALAP (As Late As Possible) algorithm. In the case of the ASAP algorithm and the delay in the arithmetic operation of 10 ns, the scheduled CDFG of FIG. 5 is generated. FIG. 5 illustrates a module F including arithmetic operations CF1 to CF4 and a module G including arithmetic operations CG1 to CG18. In FIG. 5, an arrow indicates a data flow, and a broken line indicates a clock cycle CCn (n: 1, 2, . . . ). The data should be stored in a register when the arrow and the broken line intersect in the scheduled CDFG of FIG. 5. That is, as illustrated in FIG. 5, a register Rm (m=1, 2, . . . ) is set at an intersection point of the arrow and the broken line. Nine registers R1 to R9 are set in the module F. Twenty registers R1 to R20 are set in the module G. The RTL description of the semiconductor integrated circuit with the higher power consumption is generated as the number of registers Rm is increased.

<FIG. 4: controlling frequency (S404)> The frequency controller 14 reduces the clock frequency of the module executing the arithmetic operation which is scheduled in scheduling (S403) with respect to the internal representation.

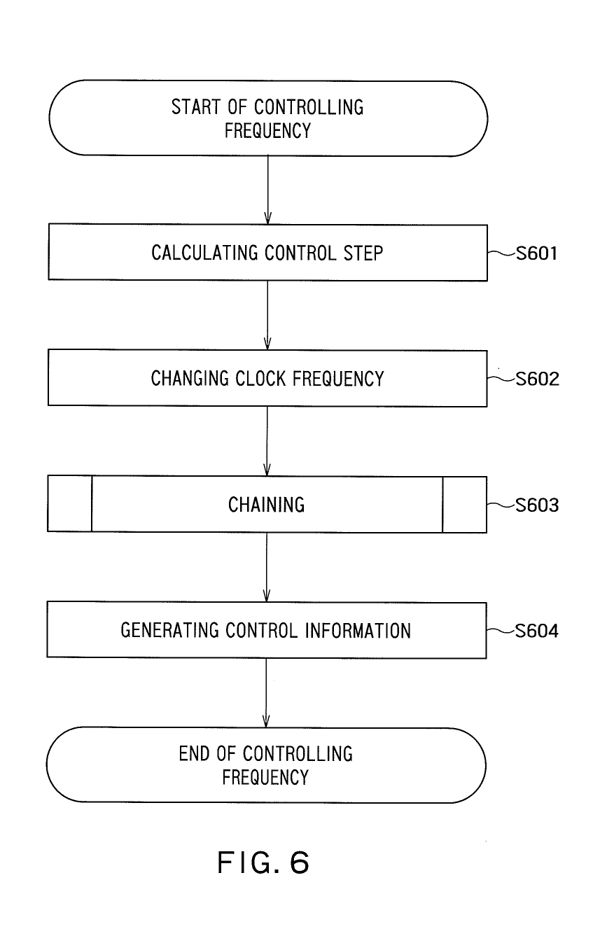

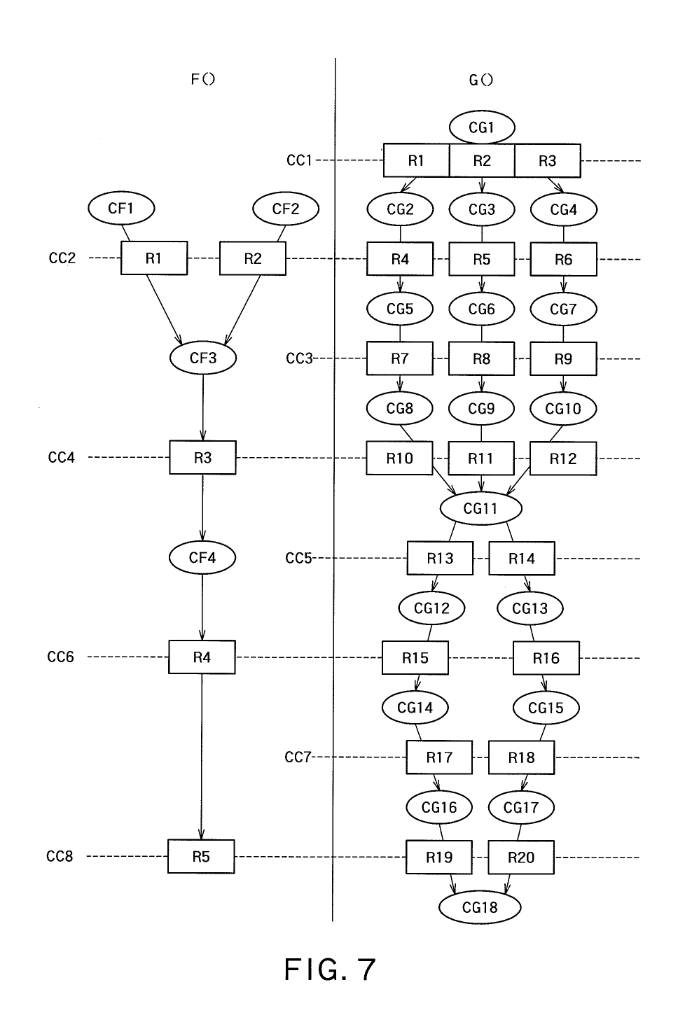

A procedure of controlling frequency (S404) will be explained. FIG. 6 is a flowchart illustrating the procedure of controlling frequency (S404) of FIG. 4. FIG. 7 is a schematic diagram illustrating an example of the CDFG corresponding to an operation result in changing clock frequency (S602) of FIG. 6.

<FIG. 6: calculating control step (S601)> The control step calculator 141 calculates the number of necessary control steps. For example, as illustrated in FIG. 5, in the CDFG generated using the ASAP algorithm, one arithmetic operation is executed in one clock cycle CCn. Accordingly, the number of clock cycles between the control step to which the first arithmetic operation is scheduled and the control step to which the final arithmetic operation is scheduled is the number of control steps necessary to execute all the arithmetic operations. In FIG. 5, the final arithmetic operations CF4 is scheduled to a control step CS2 for the module F, and the final arithmetic operations CG18 is scheduled to a control step CS8 for the module G. Accordingly, the number of necessary control steps of the module F is 3, and the number of necessary control steps of module G is 9. The control step calculator 141 can also calculate the number of necessary control steps of the CDFG generated using the other algorithm such as a ALAP algorithm or other algorithms.

<FIG. 6: changing clock frequency (S602)> The clock frequency changer 142 reduces the clock frequency of the module based on the number of necessary control steps calculated in calculating control step (S601). More specifically, the clock frequency changer 142 calculates a new clock frequency using the equation 1. For example, in FIG. 5, the original clock frequency (f) is 100 MHz, the number of necessary control steps (S_{F}) of the module F is 3, the number of necessary control steps (S_{G}) of the module G is 9, and the cycle constraint (C) is 8. Accordingly, a new clock frequency (F_{F}) of the module F is about 50 MHz, and a new clock frequency (f′_{G}) of the module G is about 112 MHz. In this case, the clock frequency of the module F is changed to 50 MHz, and the clock frequency of the module G is retained at 100 MHz. As a result, the CDFG illustrated in FIG. 7 is generated. Compared with that of FIG. 5, the number of registers of the module F in FIG. 7 decreases because the clock frequency of the module F in the CDFG of FIG. 7 is a half of that of FIG. 5. More specifically, the number of registers of the module F is 9 (R1 to R9) in FIG. 5, while the number of registers of the module F is 5 (R1 to R5) in FIG. 7. In other words, the RTL description having the lower power consumption is generated from the CDFG of FIG. 7 than that of FIG. 5.

f′=f×S/C (Equation 1)

[f: original clock frequency]

[f′: new clock frequency]

[S: the number of necessary control steps]

[C: cycle constraint]

<FIG. 6: chaining (S603)> The chaining module 143 changes the control step of the arithmetic operation that is executed by the module having the clock frequency changed in changing clock frequency (S602).

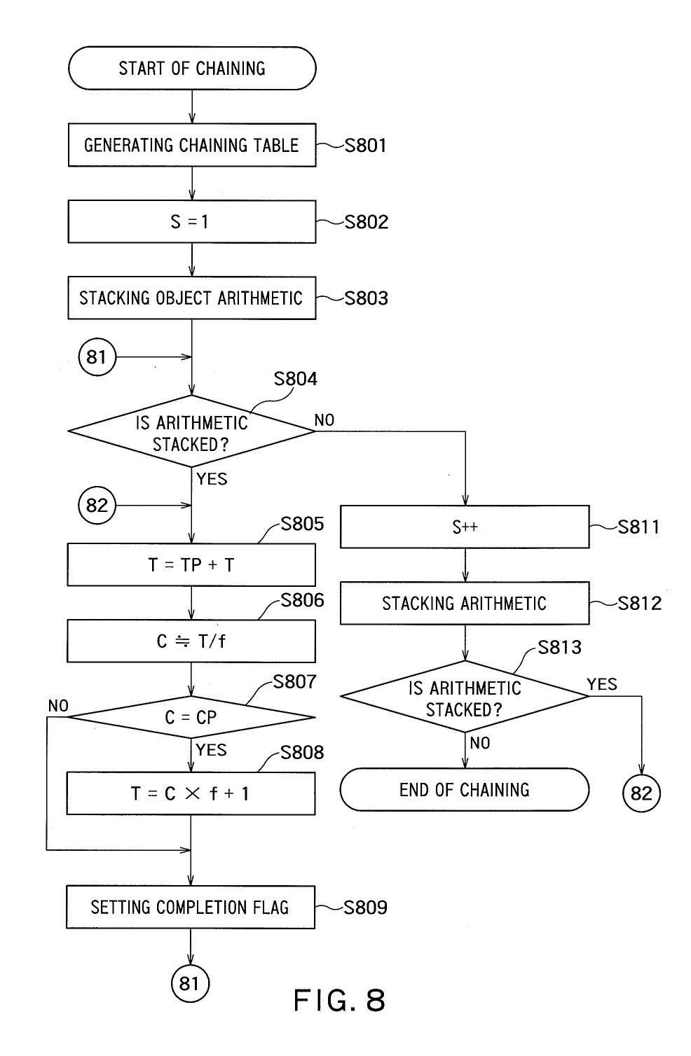

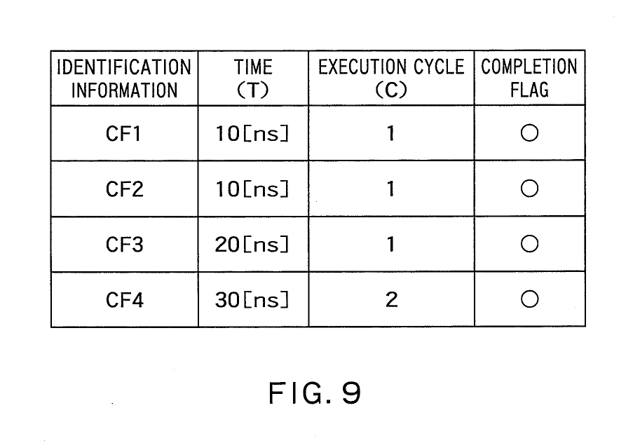

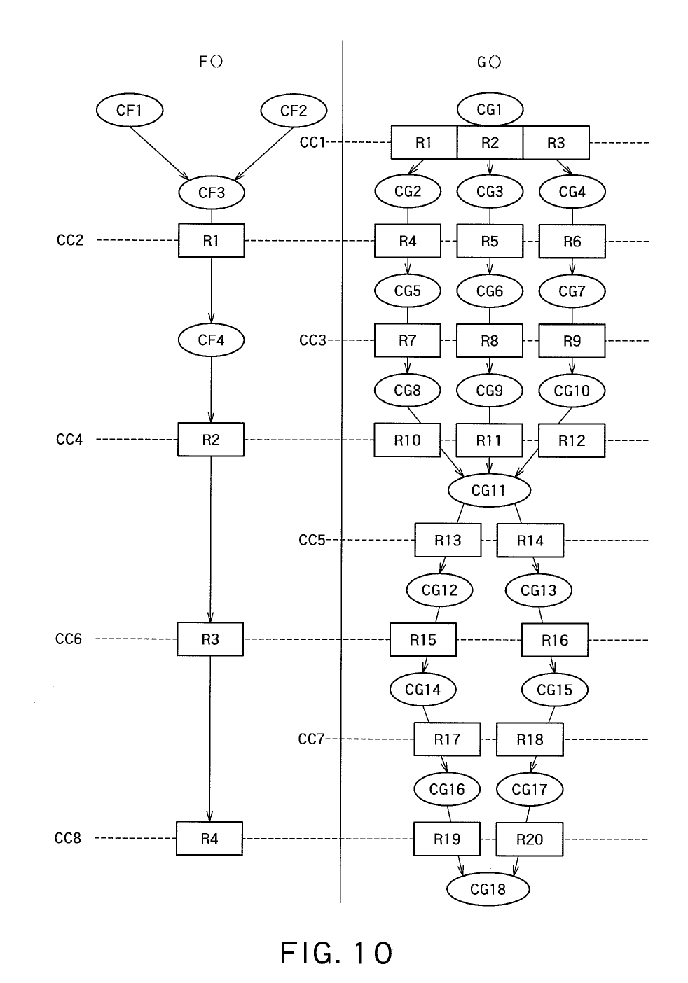

A procedure of chaining (S603) will be explained. FIG. 8 is a flowchart illustrating the procedure of chaining (S603) of FIG. 6. FIG. 9 is a schematic diagram illustrating an example of a chaining table used in chaining (S603) of FIG. 6. FIG. 10 is a schematic diagram illustrating an example of a result of chaining (S603) of FIG. 6.

<FIG. 8: S801> The chaining module 143 generates the chaining table based on the library received in inputting (S401). As illustrated in FIG. 9, the chaining table includes “identification information” identifying the arithmetic of the CDFG, a “time (T)” indicating the time in which the arithmetic operation completes, an “execution cycle (C)” indicating the cycles in which the arithmetic operation completes, and a “completion flag” indicating that chaining (S603) has been completed. The library includes the identification information on the arithmetic operations.

<FIG. 8: S802> The chaining module 143 sets an initial value of 1 to a variable S. The variable S corresponds to the identification information on the arithmetic operation (hereinafter referred to as an “object arithmetic”) dealt with in chaining (S603).

<FIG. 8: S803> The chaining module 143 stacks the arithmetic in which the value of the “identification information” and the value of the variable S are matched with each other. That is, the arithmetic corresponding to the initial value set to the variable S in S802 is stacked as the object arithmetic.

<FIG. 8: S804> The chaining module 143 determines whether the arithmetic is stacked. When the arithmetic is stacked (YES in S804), the flow goes to S805. When the arithmetic is not stacked (NO in S804), the flow goes to S811. That is, the flow goes to S805 when the arithmetic corresponding to the initial value exists, and the flow goes to S811 when the arithmetic corresponding to the initial value does not exist.

<FIG. 8: S805> The chaining module 143 sets a value of “TP+T” to the “time (T)” of the object arithmetic. TP is the maximum value of values of the “times (T)” of the arithmetics (hereinafter referred to as an “anticipatory arithmetic”) in which the value of the identification information is smaller than the value of the variable S. Therefore, the execution time (tentative execution time) of the arithmetic corresponding to the variable S is fixed.

<FIG. 8: S806> The chaining module 143 sets a value in which “T/f” is rounded up to “execution cycle (C)”. Therefore, the “execution cycle (C)” of the arithmetic corresponding to the variable S is fixed as “C+1”.

<FIG. 8: S807> The chaining module 143 determines whether the value of the “execution cycle (C)” is matched with the value of the execution cycle (CP) of the anticipatory arithmetic. The flow goes to S808 when the value of the “execution cycle (C)” is matched with the value of the execution cycle (CP) of the anticipatory arithmetic (YES in S807). The flow goes to S809 when the value of the “execution cycle (C)” is not matched with the value of the execution cycle (CP) of the anticipatory arithmetic (NO in S807).

<FIG. 8: S808> The chaining module 143 sets a value of “C×f′+T” to “time (T)”, thereby fixing the execution time of the arithmetic corresponding to the variable S.

<FIG. 8: S809> The chaining module 143 sets “completion flag” of the object arithmetic to the flag, thereby recording the arithmetic in which chaining is completed.

<FIG. 8: S811> The chaining module 143 increments the variable S, thereby changing the object arithmetic.

<FIG. 8: S812> The chaining module 143 stacks the arithmetic in which the value of “identification information” and the value of the variable S are matched with each other. Therefore, the arithmetic corresponding to the value set to the variable S in S811 is stacked as the object arithmetic.

<FIG. 8: S813> The chaining module 143 determines whether the arithmetic is stacked. The flow returns to S805 when the arithmetic is stacked (YES in S811). Chaining (S603) is ended when the arithmetic is not stacked (NO in S813).

A specific example of chaining (S603) will be explained.

First, the chaining table of FIG. 7 is generated.

Then, the arithmetics CF1 and CF2 of FIG. 7 are stacked. Because the anticipatory arithmetics of the arithmetics CF1 and CF2 do not exist, the execution times of 10 ns of the arithmetics CF1 and CF2 are set to the “time (T)” of the arithmetics CF1 and CF2. Then, the “execution cycles” of the arithmetics CF1 and CF2 are set to 1. The value of the “time (T)” is divided by a clock period (20 ns), and the quotient (“time (T)”/“clock period”) is rounded up to calculate the “execution cycle (C)”. Then, the “completion flags” of the arithmetic CF1 and CF2 are set to “0”.

Then, the arithmetic CF3 subsequent to the arithmetics CF1 and CF2 is stacked. Then, the “time (T)” of the arithmetic CF3 is set to 20 ns, which is the sum of 10 ns that is of the execution time of the arithmetic CF3 and the time of 10 ns of the arithmetic CF1 or arithmetic CF2 that is of the anticipatory arithmetic. Then, the “execution cycle” of the arithmetic CF3 is set to 1. Then, the “completion flag” of the arithmetic CF3 is set to “0”.

Then, the arithmetic CF4 subsequent to the arithmetic CF3 is stacked. Then, the “time (T)” of the arithmetic CF4 is set to 30 ns which is the sum of 10 ns that is of the execution time of the arithmetic CF4 and the time of 20 ns of the arithmetic CF3 that is of the anticipatory arithmetic. Then, the “execution cycle” of the arithmetic CF4 is set to 2. Then, the “completion flag” of the arithmetic CF4 is set to “0”.

As a result, the CDFG illustrated in FIG. 10 is generated. In the CDFG of FIG. 10, because the arithmetics CF1 to CF3 are done in the same control step, the number of registers of the module F decreases compared with the CDFG of FIG. 7. That is, the number of registers of the module F is 4 (L1 to L4) in FIG. 10. Compared with the CDFG of FIG. 7, the RTL description with the lower power consumption is generated from the CDFG of FIG. 10.

<FIG. 6: generating control information (S604)> The control information generator 144 generates the control information. The control information includes the value of change of the clock frequency changed in changing clock frequency (S602) and the identification information on the module having the changed clock frequency. For example, when the CDFG of FIG. 10 is generated in chaining (S603), the change amount is 50 MHz, and the identification information on the module is “F”.

Controlling frequency (S404) of FIG. 4 is ended after generating clock frequency (S604) of FIG. 6.

<FIG. 4: allocating (S405)> The allocator 15 fixes the circuit configuration of the semiconductor integrated circuit such that the module operates at the clock frequency changed in controlling frequency (S404). For example, when the CDFG of FIG. 10 is generated in chaining (S603), the allocator 15 fixes the circuit configuration that realizes the CDFG of FIG. 10.

<FIG. 4: generating RTL description (S406)> The RTL description generator 16 generates the RTL description from the internal representation based on the result of allocating (S405). For example, when the CDFG of FIG. 10 is generated in chaining (S603), the RTL description generator 16 generates the RTL description of the semiconductor integrated circuit that realizes the CDFG of FIG. 10. Therefore, the RTL description of the semiconductor integrated circuit having the lower power consumption than that of the semiconductor integrated circuit that realizes the CDFG of FIG. 5 generated in generating internal representation (S402).

<FIG. 4: outputting (S407)> The outputting module 17 outputs the RTL description generated in generating RTL description (S406) and the control information generated in generating control information (S604) to the outputting apparatus 40. Therefore, compared with the conventional method, the RTL description of the semiconductor integrated circuit having the lower power consumption is obtained.

The high-level synthesis operation of FIG. 4 is ended after outputting (S407).

According to the embodiment, the frequency controller 14 controls the clock frequency of the module that executes the arithmetic operation so as to reduce the number of registers. Therefore, compared with the conventional method, the RTL description of the semiconductor integrated circuit having the lower power consumption is obtained.

Additionally, according to the embodiment, the chaining module 143 changes the control step of the arithmetic operation. Therefore, the RTL description of the semiconductor integrated circuit having the further low power consumption is obtained.

At least a portion of the high-level synthesis apparatus 10 according to the above-described embodiments may be composed of hardware or software. When at least a portion of the high-level synthesis apparatus 10 is composed of software, a program for executing at least some functions of the high-level synthesis apparatus 10 may be stored in a recording medium, such as a flexible disk or a CD-ROM, and a computer may read and execute the program. The recording medium is not limited to a removable recording medium, such as a magnetic disk or an optical disk, but it may be a fixed recording medium, such as a hard disk or a memory.

In addition, the program for executing at least some functions of the high-level synthesis apparatus 10 according to the above-described embodiment may be distributed through a communication line (which includes wireless communication) such as the Internet. In addition, the program may be encoded, modulated, or compressed and then distributed by wired communication or wireless communication such as the Internet. Alternatively, the program may be stored in a recording medium, and the recording medium having the program stored therein may be distributed.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

1. A system for high-level synthesis comprising:
an input configured to receive
a behavioral description of a digital system, the behavioral description comprising arithmetic operations, and
one or more architectural constraints;
an internal design representation processor configured to generate a flow graph from the behavioral description, wherein the flow graph comprises
arithmetic nodes representing the arithmetic operations and
control steps for executing the arithmetic operations represented by the arithmetic nodes;
a scheduler configured to schedule the arithmetic nodes of the flow graph, subject to the number of control steps and the one or more constraints;
a frequency controller configured to change a clock frequency of the digital system based on a result of the scheduler;
an allocator configured to set a circuit configuration of the digital system, wherein the allocator is configured to account for the changed clock frequency;
a register transfer level description processor configured to generate a register transfer level description from the flow graph, based on a result of the allocator; and
an output module configured to output the register transfer level description.

2. The high-level synthesis system of claim 1, wherein the frequency controller comprises:
a control step calculator configured to calculate the minimum number of control steps needed to execute all the arithmetic operations represented by the arithmetic nodes; and
a clock frequency changer configured to reduce the clock frequency based on the minimum number of control steps.

3. The high-level synthesis system of claim 1, wherein the frequency controller comprises a chaining module configured to reduce the number of control steps to the minimum number of control steps needed to execute the arithmetic operations represented by the arithmetic nodes, such that the frequency controller is configured to reduce the clock frequency of the digital system.

4. The high-level synthesis system of claim 2, wherein the frequency controller comprises a chaining module configured to reduce the number of control steps to the minimum number of control steps needed to execute the arithmetic operations represented by the arithmetic nodes, such that the frequency controller is configured to reduce the clock frequency of the digital system.

5. The high-level synthesis system of claim 1,
wherein the frequency controller further comprises a control information generator configured to generate
control information comprising a change amount of the clock frequency and
identification information regarding the digital system having the reduced clock frequency, and
wherein the outputting module further outputs the control information.

6. The high-level synthesis system of claim 2,
wherein the frequency controller further comprises a control information generator configured to generate
control information comprising a change amount of the clock frequency and
identification information regarding the digital system having the reduced clock frequency, and
wherein the outputting module further outputs the control information.

7. The high-level synthesis system of claim 3,
wherein the frequency controller further comprises a control information generator configured to generate
control information comprising a change amount of the clock frequency and
identification information regarding the digital system having the reduced clock frequency, and
wherein the outputting module further outputs the control information.

8. The high-level synthesis system of claim 4,
wherein the frequency controller further comprises a control information generator configured to generate
control information comprising a change amount of the clock frequency and
identification information regarding the digital system having the reduced clock frequency, and
wherein the outputting module further outputs the control information.

9. A method for causing a computer system to perform high-level synthesis, the method comprising:
generating an internal design representation from a behavioral description of a digital system, the internal design representation comprising
arithmetic nodes representing arithmetic operations and
control steps for executing the arithmetic operations represented by the arithmetic nodes;
scheduling the arithmetic operations in the internal representation based on the number of control steps;
changing a clock frequency of the digital system, based on a result of the scheduling;
accounting for the changed clock frequency, setting a circuit configuration of the digital system;
based on the circuit configuration, generating a register transfer level description from the internal representation; and
outputting the register transfer level description.

10. The method of claim 9, wherein changing the clock frequency comprises
calculating the minimum number of control steps needed to execute all the arithmetic operations and
reducing the clock frequency based on the minimum number of control steps.

11. The method of claim 9, wherein changing the clock frequency comprises reducing the number of control steps to the minimum number of control steps needed to execute the arithmetic operations represented by the arithmetic nodes, such that the clock frequency of the digital system is reduced.

12. The method of claim 10, wherein changing the clock frequency comprises reducing the number of control steps to the minimum number of control steps needed to execute the arithmetic operations represented by the arithmetic nodes, such that the clock frequency of the digital system is reduced.

13. The method of claim 9,
wherein changing the clock frequency further comprises
generating control information comprising a change amount of the clock frequency and
generating identification information regarding the digital system having the reduced clock frequency, and
wherein outputting the register transfer level description further comprises outputting the control information.

14. The method of claim 10,
wherein changing the clock frequency further comprises
generating control information comprising a change amount of the clock frequency and
generating identification information regarding the digital system module having the reduced clock frequency, and
wherein outputting the register transfer level description further comprises outputting the control information.

15. The method of claim 11,
wherein changing the clock frequency further comprises
generating control information comprising a change amount of the clock frequency and
generating identification information regarding the digital system having the reduced clock frequency, and
wherein outputting the register transfer level description further comprises outputting the control information.

16. The method of claim 12,
wherein changing the clock frequency further comprises
generating control information comprising a change amount of the clock frequency and
generating identification information regarding the digital system having the reduced clock frequency, and
wherein outputting the register transfer level description further comprises outputtting the control information.

17. A non-transitory computer readable medium having stored thereon computer-executable program code embodying a method for causing a computer system to perform high-level synthesis, the method comprising:
generating an internal design representation from a behavioral description of a digital system, the internal design representation comprising
arithmetic nodes representing arithmetic operations and
control steps for executing the arithmetic operations represented by the arithmetic nodes;
scheduling the arithmetic operations in the internal representation based on the number of control steps;
changing a clock frequency of the digital system based on a result of the scheduling;
accounting for the changed clock frequency, setting a circuit configuration of the digital system;
based on the circuit configuration, generating a register transfer level description from the internal representation; and
outputting the register transfer level description.

18. The medium of claim 17, wherein the method comprises
calculating the minimum number of control steps needed to execute all the arithmetic operations and
reducing the clock frequency based on the minimum number of control steps.

19. The medium of claim 17, wherein the method comprises
reducing the number of control steps to the minimum number of control steps needed to execute the arithmetic operations represented by the arithmetic nodes, such that the clock frequency of the digital system is reduced.

20. The medium of claim 18, wherein the method comprises
reducing number of control steps to the minimum number of control steps needed to execute the arithmetic operations represented by the arithmetic nodes, such that the clock frequency of the digital system is reduced.
